(19) United States
(12) Patent Application Publication
(10) Pub. No.: US 2010/0198647 A1
(43) Pub. Date: Aug. 5, 2010

(54) TECHNICAL HOTLINE RESOURCE MANAGEMENT METHOD AND SYSTEM

(75) Inventors: Wayne Randolph Bowers,, JR., Belleville, MI (US); Albert William Whitmyer, Brighton, MI (US); Shawn Daniel Brozovich, Farmington Hills, MI (US); Kevin J. Ricks, South Lyon, MI (US)

Correspondence Address: Ford Global;c/o Shook, Hardy & Bacon L.L.P., Intellectual Property Department, 2555 Grand Blvd., Kansas City, MO, 64108, US

(73) Assignee: Ford Motor Company, Dearborn, MI (US)

(21) Appl. No.: 12/364,196

(22) Filed: Feb. 2, 2009

(51) Int. Cl. G06Q 10/00; G06F 3/048; G06Q 50/00

(52) U.S. Cl. 705/9; 705/11; 705/32; 715/733; 705/1.1

(57) ABSTRACT

A technical hotline resource management method and system provides a business solution for contact centers which receive contacts both through telephone-based inquiries and web-based inquiries. The disclosed method and system provides, among other things, intelligent calculation of projected resource requirements, a common schedule template for all groups engaged in providing technical assistance, simple input and maintenance screens, a readily-viewed calendar of employee schedules, detailed employee profiles (which identify employee skills), and options for scheduling different work types during given increments of time. Having such information readily available the technical hotline resource manager can thus readily review lists of available employees, groups, and technical requests and can route the inquiries efficiently and quickly. Using the disclosed method and system the resource manager is able to schedule different work types over the contact information, thus enabling employees to be assigned to various work types, including responsibility for different types of inquiries (telephone-based and web-based) as well as for training and meetings, avoiding unnecessary work beyond standard work schedules.

### TECHNICAL FIELD

The invention disclosed herein relates generally to business contact centers which utilize both telephone and web-based forms of communication. More particularly, the disclosed invention relates to a single resource management system which incorporates assistance for both incoming telephone calls and web-based inquiries by providing a single software application which encompasses all of the aspects of resource management, including timekeeping, forecasting needs based on historical trends, routing of contacts based on agent skills and contact demand, quality control and performance metrics.

### BACKGROUND OF THE INVENTION

A broad variety of commercial enterprises provide customer service representatives or customer service agents to respond to technical inquiries. Businesses are generally aware that it is in their best interest to provide complete and competent responses to technical customer inquiries which are delivered in an expeditious manner.

Initially these inquiries were directed to the company by way of mail, thus giving the company receiving the mail a good amount of time to identify the best person to respond to the inquiry and then to have that person provide the response in due course. This arrangement changed dramatically with the advent of telephone-based technical contact centers in which real-time responses were needed. Virtually instantaneously call center operators were responsible for receiving calls, comprehending the caller's inquiry, categorizing the technical matter in question, determining the technician(s) best suited to respond to the question, determining the availability of the identified technician, routing the call to the technician, and confirming receipt of the routed call. Multiple problems arise in such a situation, including the clarity of the question, the ability of the call center operator, the ease of determining the best technician to handle the matter, and the availability of the identified person at any given time on any given day.

These problems were compounded with the introduction of web-based technical contact centers which did not relieve the telephone-based operators of their duties but which required an entirely different set of operators to handle similar, but not always the same, types of challenges using a different medium. Current technology is not available to address the complete business needs for contact centers which receive contacts through both phone calls and web-based forms.

Accordingly, a need exists today for an improved system for providing an integrated system capable of handling both telephone-based and web-based technical inquiries.

### SUMMARY OF THE INVENTION

A preferred embodiment of the disclosed invention is a single resource management method and system that incorporates both web based assistance requests and incoming phone calls. A single software application is provided which encompasses all of the aspects of resource management, including timekeeping, forecasting needs based on historical, trends, routing of contacts based on agent skills and contact demand, quality control and performance metrics.

More particularly, the disclosed invention includes a system for managing resources available to a contact center in response to both telephone-based and web-based inquiries which comprises an employee availability listing component, an employee profile component which includes employee skill identification, a request listing component, and a routing component for routing a request to an employee based on availability and skill. The employee availability listing component includes a maintenance screen, said screen being capable of displaying data selected from the group consisting of the identities of the employees in a group, employee availability at a given time, scheduled overtime, time off, status of schedule approvals or changes, and scenarios that might arise due to employee unavailability due to illness, early departure, a change in employee work type, or transfer to a different work group.

The system operates based upon a computer readable medium of instructions for providing resource management and for controlling a contact center to receive telephone-based and web-based inquiries and to respond to these inquiries. The computer readable medium of instructions comprises data representing employee availability, employee profiles (including but not limited to employee skill and performance metrics), inquiry routing, and timekeeping.

Other features of the invention will become apparent when viewed in light of the detailed description of the preferred embodiment when taken in conjunction with the attached drawings and the appended claims.

### BRIEF DESCRIPTION OF THE DRAWINGS

For a more complete understanding of this invention, reference should now be made to the embodiment illustrated in greater detail in the accompanying drawings and described below by way of examples of the invention wherein:

FIG. 1 is a flow chart illustrating an exemplary single resource management system according to the disclosed invention;

FIG. 2 illustrates an exemplary interface of a computer program module demonstrating aspects under the control of the system administrator;

FIG. 3 illustrates an exemplary interface of a computer program module demonstrating different technical groups from which the administrator can select;

FIG. 4 illustrates an exemplary interface of a computer program module demonstrating the daily schedule for all employees in a given group at certain time increments;

FIG. 5 illustrates an exemplary interface of a computer program module visually demonstrating all of the pertinent data needed by the resource manager to make work resource decisions based upon such information as schedule availability, total resources, projected requirements, and projected status;

FIG. 6 illustrates an exemplary interface of a computer program module demonstrating the administrator's ability to identify a time slot in which a projected status needs adjustment;

FIG. 7 illustrates an exemplary interface of a computer program module demonstrating the administrator's ability to view a given employee's production capabilities;

FIG. 8 illustrates an exemplary interface of a computer program module demonstrating an edit screen that is opened by the administrator which allows the change of the scheduled work type;

FIG. 9 illustrates an exemplary interface of a computer program module demonstrating a drop-down from the edit screen of FIG. 8;

FIG. 10 illustrates an exemplary interface of a computer program module demonstrating the availability of important information needed for making a decision regarding schedule change; and

FIG. 11 illustrates an exemplary interface of a computer program module demonstrating the administrator's ability to view a given employee's preferred schedule.

### DETAILED DESCRIPTION OF THE PREFERRED EMBODIMENT

In the following figures, the same reference numerals will be used to refer to the same components. In the following description, various operating parameters and components are described for one constructed embodiment. These specific parameters and components are included as examples and are not meant to be limiting.

The disclosed invention increases response efficiency in both time and response quality while reducing the number of employees needed. In the past when better response time was needed call centers would resolve this problem by simply hiring additional employees. According to the disclosed approach a single resource manager is able to identify (1) which employee has the best technical skill to provide the response and (2) which employee is best equipped to handle the type of inquiry (telephone vs. web-based) based on efficiency from an historic record of work. This data is used to populate the resource information immediately available to the resource manager.

The disclosed invention is highly adaptable and enables the resource manager to respond quickly and completely to changes in inquiry volume during the day. For example, during certain parts of the work day the web-based volume is heavier at certain times than the telephone-based volume. Using the disclosed invention the resource manager can easily modify the work schedule to compensate for changes in volume for any given time segment of any given work day.

The disclosed invention also allows the resource manager to find all of the needed information regarding employee skill set and availability at a single place. Particularly, by viewing the schedule screen, the resource manager is able to mouse over a technician and identify that technician's work skills, efficiency regarding handling different forms of inquiry, and work schedule. Using the same screen the resource manager can also readily change work tasks and work schedules. There is no need for the resource manager to review multiple administrative screens.

An additional feature of the disclosed invention is the ability of the system to respond to an important requirement in call centers, which is for continuous employee training. New employees need to be trained efficiently and completely on how to respond to inquiries and existing employees need to be continually trained on system changes as well as in changes in technology. Under the disclosed invention the resource manager can readily identify slow times experienced by a technician at certain times during certain days. When a slow time is identified the resource manager can send a virtually instantaneous e-mail message to the particular employee instructing the employee to use a certain segment for web-based training. This approach not only maintains high quality technical skill among the responsible technicians but also prevents the need for employees to undertake training as overtime.

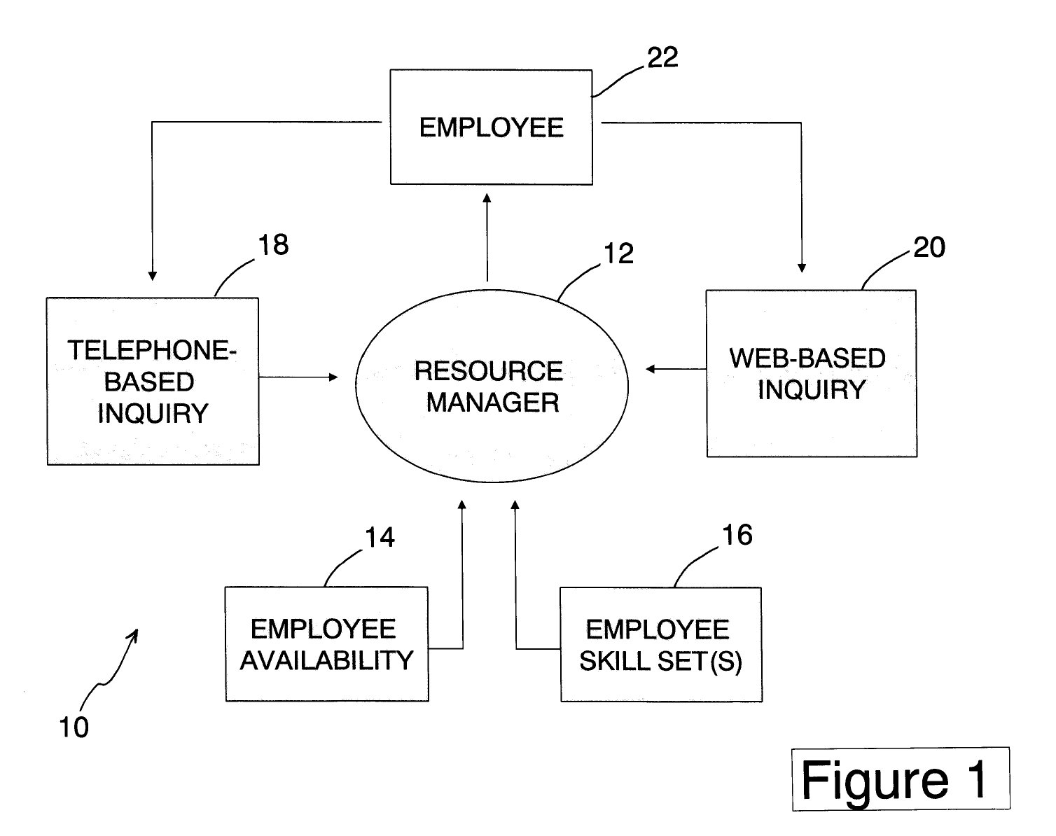

With reference to FIG. 1, a flow chart is shown which illustrates an exemplary single resource management system according to the disclosed invention which provides an intelligent calculation of projected resource requirements. The system, generally illustrated as 10, is generally directed at providing a resource manager 12 with appropriate information related to employee availability 14 and employee skills 16. In the event that a telephone-based inquiry 18 or a web-based inquiry 20 is made, the resource manager 12 determines the appropriate employee to respond to the inquiry based upon information such as employee availability and employee skills. Once the resource manager 12 makes the appropriate determination, the inquiry is forwarded to the employee 22 who then provides the appropriate response to the telephone-based inquiry 18 or the web-based inquiry 20.

### Employee Availability

The resource manager 12 is provided with data directed to employee availability 14. Employees can upload a preferred schedule (with requests for exceptions) and can remotely view proposed and approved work schedules and may respond with changes as may be needed. In addition, an employee can report an absence through the website. For example, in the event of illness an employee can input the information. The resource manager 12 is automatically notified of absent employees and an absentee report is generated. (The employee's only input under the disclosed system is to provide information as to work schedule.)

### Employee Skills

The resource manager 12 is provided with data directed to employee skills 16. To provide a proper, competent and complete response to an inquiry it is critical that the received inquiry be forwarded to an employee having the proper skills to form and deliver a proper response. Accordingly, a comprehensive employee profile is built and is made available to the resource manager 12. To this end employee profile data is provided to the resource manager 12 in the form of the employee's primary skill set and the employee's secondary skill set. The employee's profile can be readily edited through the addition or deletion of information as required by the appropriate user.

### Data Display

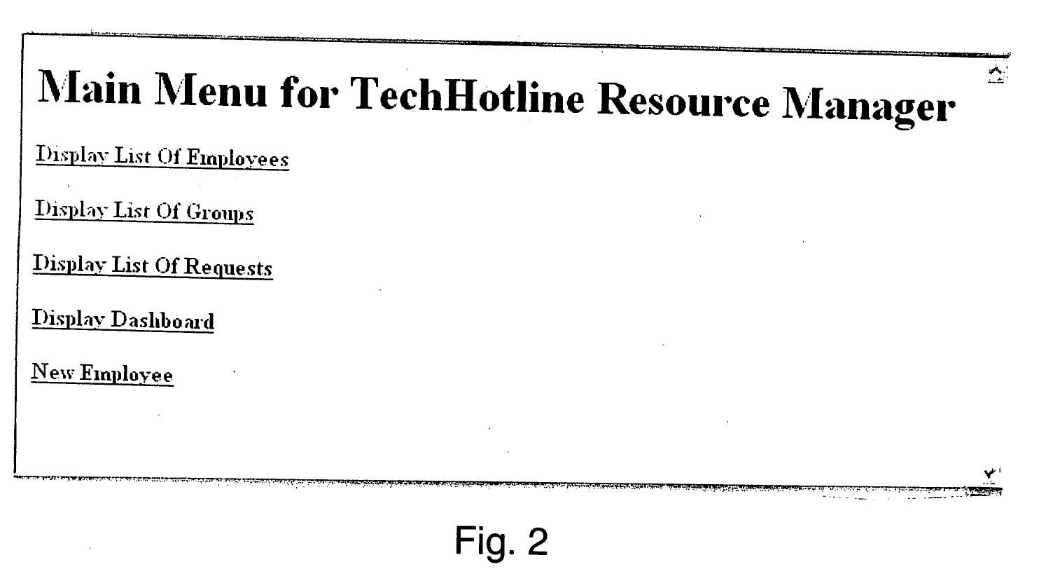

FIGS. 2 through 13 illustrate a number of computer modules which are accessible by the administrator. These screens are set forth for illustrative purposes only and are not intended as being limiting as several variations, including format and content, are envisioned. The screens offer calendar views of schedules at a glance and thus readily and completely provide the information needed by the administrator to make informed decisions as to how to route the received inquiry. While the actual format can be altered without deviating from the disclosed invention, the figures demonstrate how the template may be common in appearance for all groups.

In general, the features of the disclosed invention are preferably constructed as modules. This arrangement simplifies the removal of features and the adding of new features as required to update or modify the system. Administrator screens are configured to allow the override of automated features as may be necessary. Preferably the data fields are formatted so as to permit 24/7 scheduling as may be needed administrator screens to allow override of automated features as necessary

The system and method of the disclosed invention offer a variety of additional conveniences. For example, system users are automatically notified in the event of schedule approvals and changes. By way of additional example, in the event that the manager changes an employee's work type or if an otherwise-scheduled employee reports in ill, unexpectedly leaves work early, or is moved between groups a difficult situation is created which runs the risk of destabilizing the resource management system. To counter this event the system disclosed herein may be programmed to create an anticipatory “what if” scenario in which one or more of these situations might arise, thus offering the administrator a pre-determined alternative course of action prior to the situation actually arising. This arrangement assures a quick and competent response.

An additional feature of the disclosed invention is the ability of the system to identify the best opportunities for training and other non-core business activities against the backdrop of work responsibilities. By relying upon scheduling data optimum times for such activities can be automatically identified and updated very quickly.

As a further convenience while the schedules are available in a readily viewed format as shown in FIGS. 2 through 13, they may also be provided in alternate formats as may be desired. For example, the schedules may be downloaded and graphed in any of several formats, including Excel® spreadsheets.

The application disclosed herein may rely upon a variety of types of software. By way of example, the application may use Microsoft® Active Server Pages (asp). In addition, it is preferred but not required that the data be managed and stored locally, such as by using a Microsoft® SOL server.

With particular reference to FIGS. 2 through 12, various exemplary interfaces of computer modules are shown. The screen configurations are provided only to serve as suggestions as possible but not mandatory formats and are thus intended as being illustrative rather than limiting.

With reference to FIG. 2, a main menu for the system administrator is shown. The menu includes options for the administrator to display a list of employees, a list of technical groups, a list of request for information, and a “display dashboard” which displays a status overview for a full week. The main menu also provides new employee information. All of these features, contained on a single menu screen, are under the control of the system administrator. For example, by selecting the “display list of requests” feature the administrator can review request for exceptions to the schedule. Clicking on the date of the request opens the schedule for a given day, allowing the administrator to check resources for the requested time.

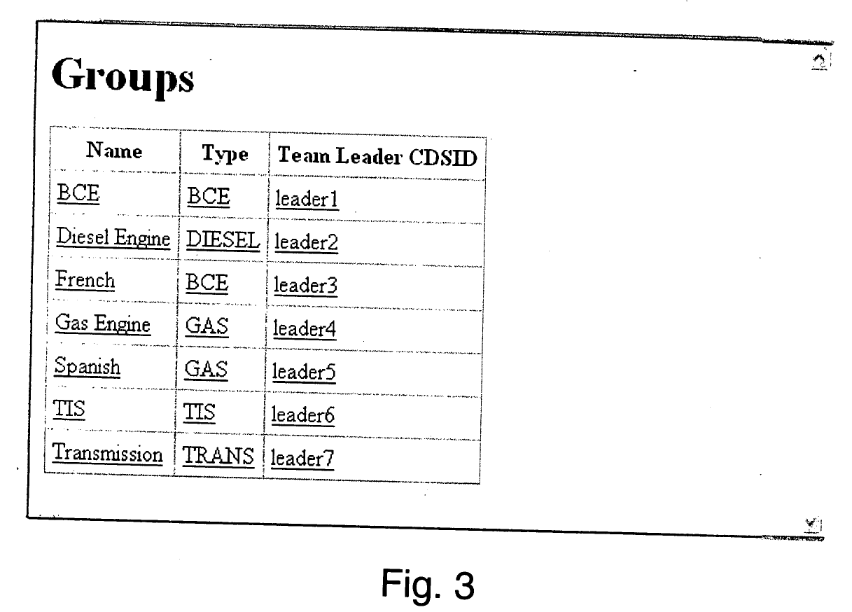

In order to identify the employee best-suited to respond to an inquiry the administrator must first identify the appropriate technical group. FIG. 3 illustrates a displayed list of groups. Once the administrator identifies the correct group, the administrator selects the group name to view the group's schedule.

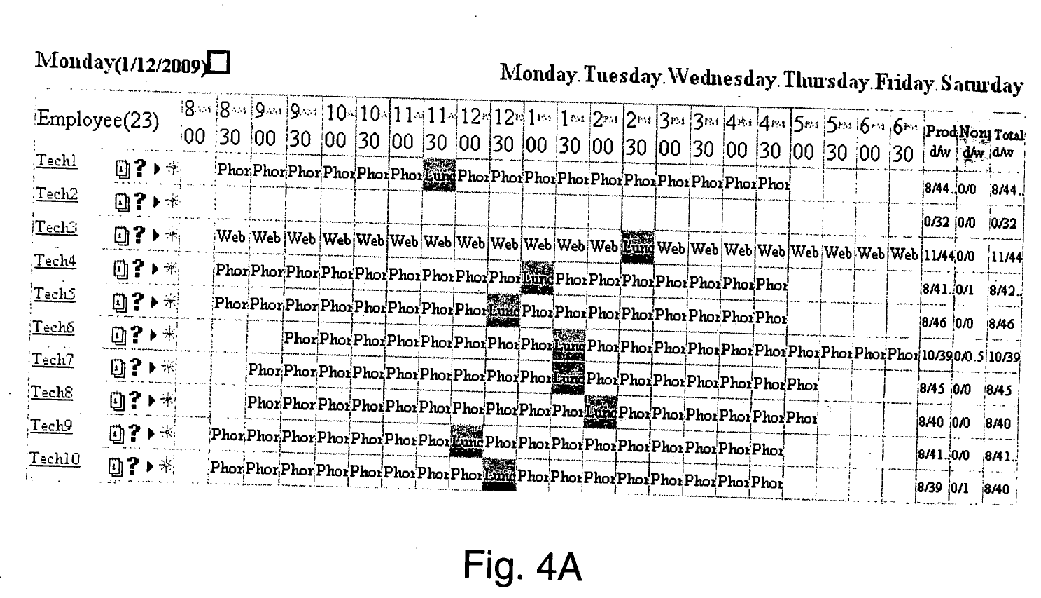

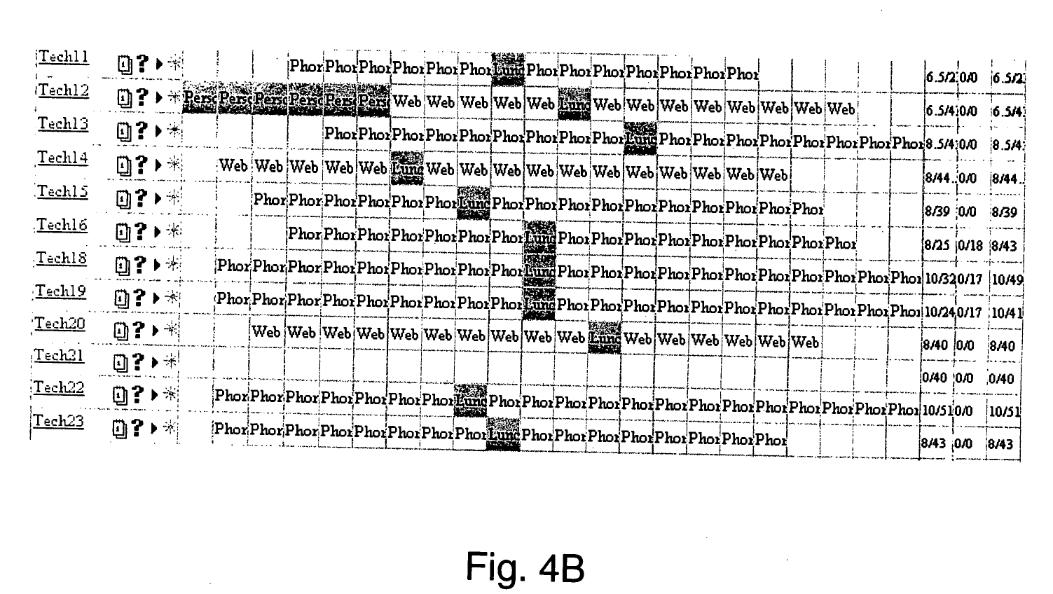

An exemplary daily schedule for the “gas engine group” is shown in FIG. 4. The names of the technicians are listed on the left column. The illustrated schedule is broken into time segments set forth in a line placed at the top end of the screen. As illustrated, the daily schedule displays all employees in the group (by name) and scheduled work type for each 30-minute increment. The time increment may be altered as required. The illustrated increments display the work type which, as illustrated in FIG. 4, includes phone work (“phone”), web work (“web”), and lunch (“lunch”). Other activities suitable to the particular application may be provided.

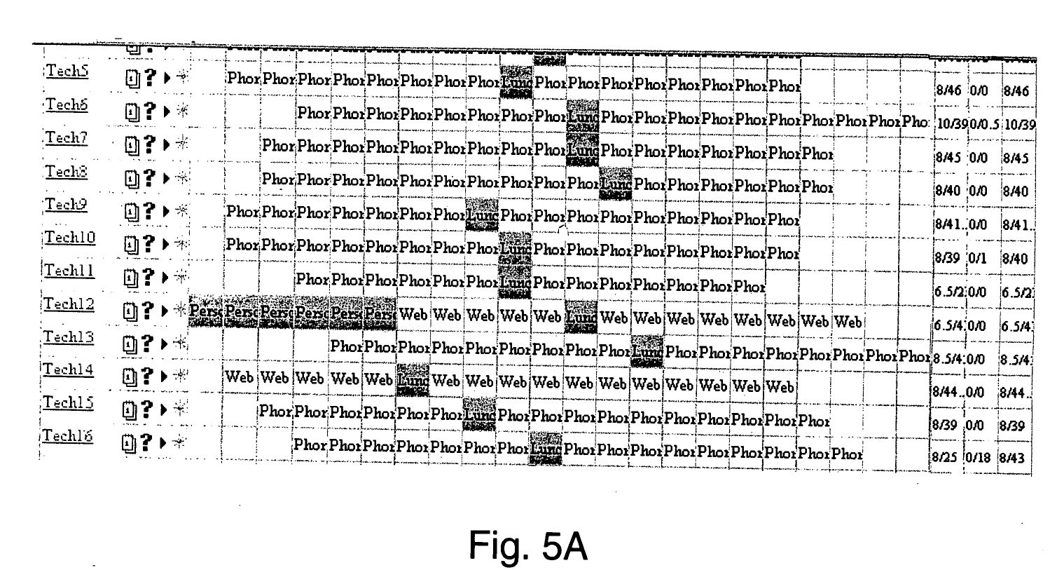

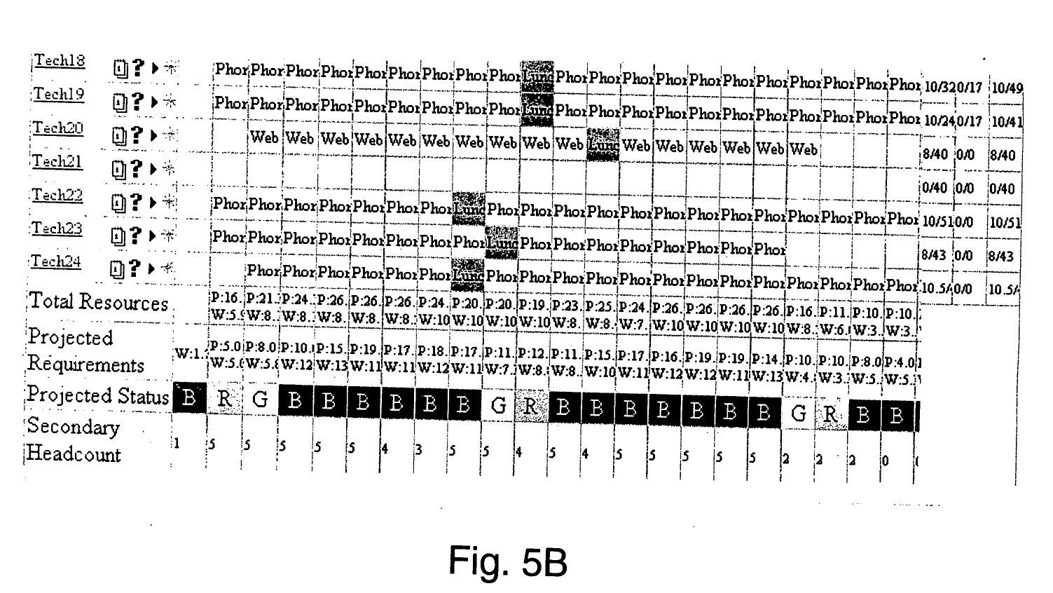

FIG. 5 is a view of the lower end of the screen of FIG. 4 representing how the screen would appear after the resource manager has scrolled to the bottom of the list of names of the technicians. As illustrated, days of the week are listed by column, with lines being divided into regular time intervals. At the lower end of the illustrated screen data is provided along the x-axis of the screen which alerts the resource manager to the “total resources” available (based on schedule and skills). For example, the third column denotes a telephone inquiry resource availability of 21 and a web-based inquiry resource availability of 8. Additional data along the x-axis of the screen (below the “total resources” data) is provided which alerts the resource manager to the “projected requirements.” Using the same second column as noted above, the projected requirements for telephone inquiries are identified as 8 while the projected requirements for web-based inquiries are identified as 5. This is a very good ratio of “total resources” to “projected requirements,” so the time slot is ranked positively under “projected status” (also on the x-axis, located below the “projected requirements”), in this case with a “G.”

The third column thus illustrates a situation which is optimal. In the event that the ratio is not as optimal, the “projected status” will be marked with a cautionary indicator, as illustrated in the second column which is marked with an “R.” The “projected status” rank of “R” was issued for this time slot because while the “total resources” for the phone-based response is 16 compared with the “projected requirements” of 5, the “total resources” for the web-based response was 5 compared with the “projected requirements” of 5, thus resulting in a cautionary rating.

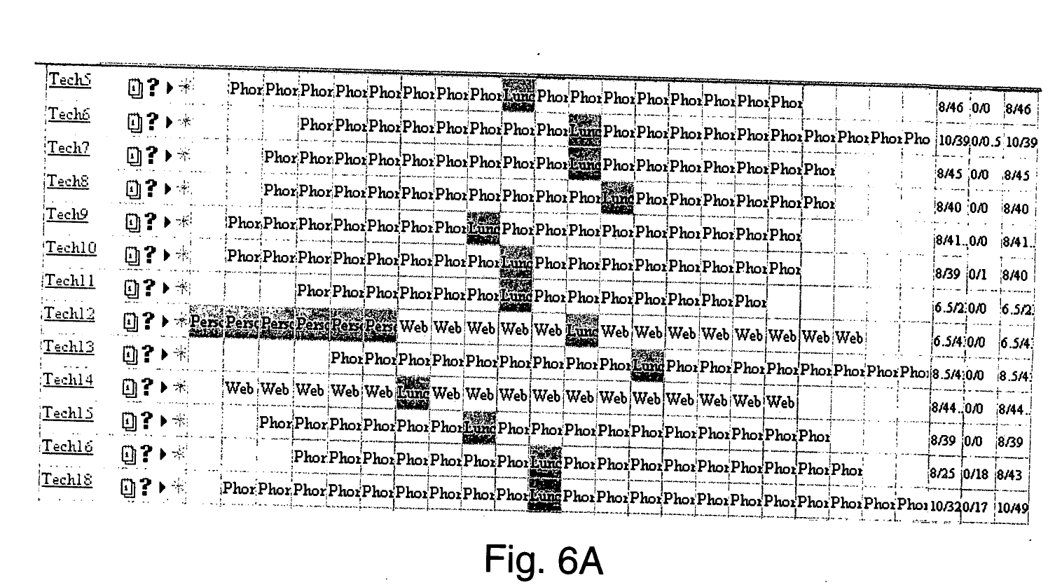

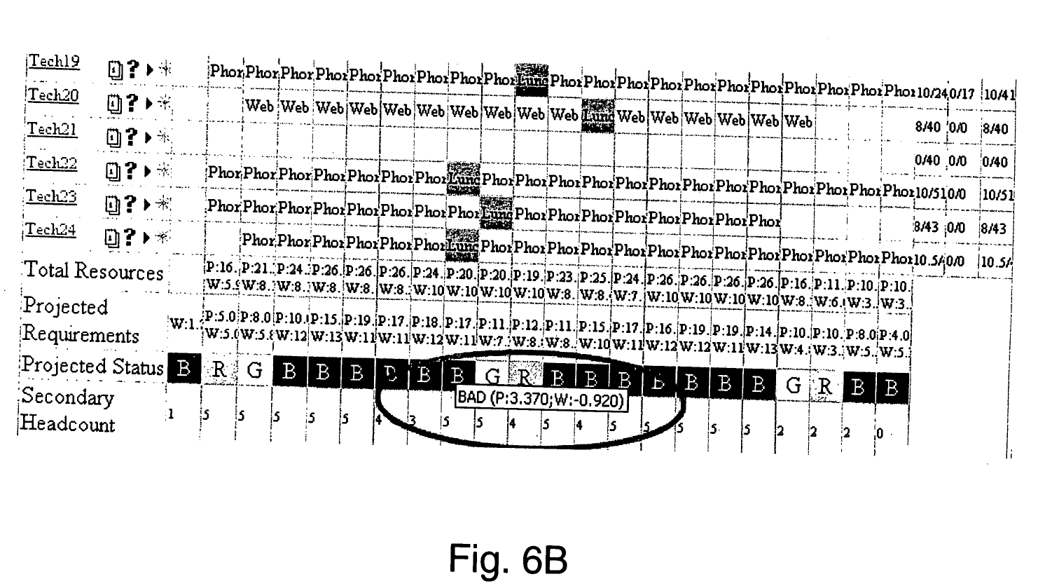

In some situations the ratio may be of greater concern to the resource manager. For example, and with reference to FIG. 6, certain “project status” grades have been circled. Using the ninth column as an example, the “total resources” are 20 for phone-based inquiries and 10 for web-based inquiries while the “projected requirements” are 17 and 11 respectively. This is a potentially problematic ratio of a small positive number for the phone based inquiry and a negative number for the web-based inquiry. Thus this time slot receives a “B” or “bad” rating and the resource manager is alerted as such.

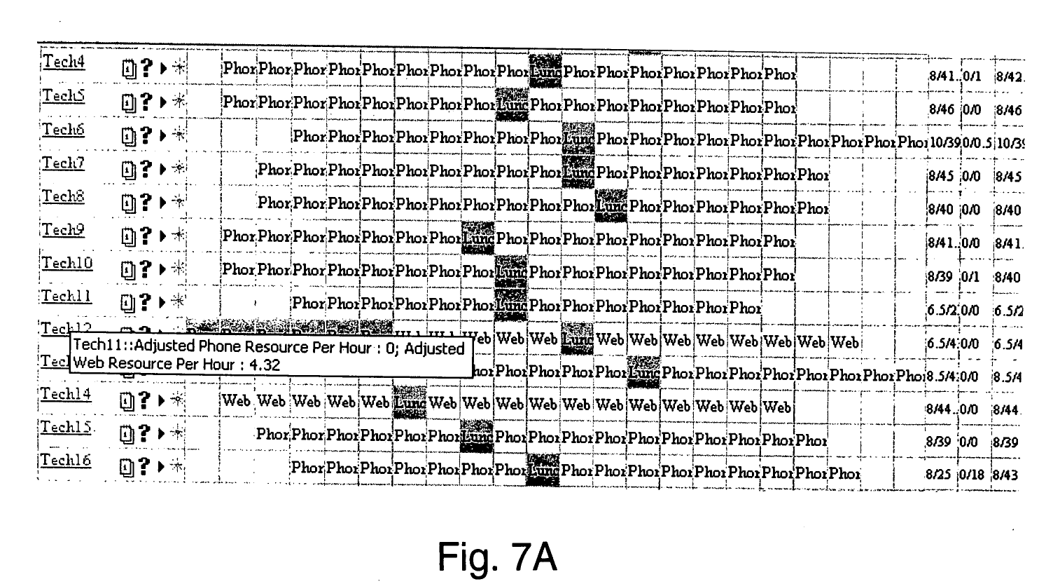

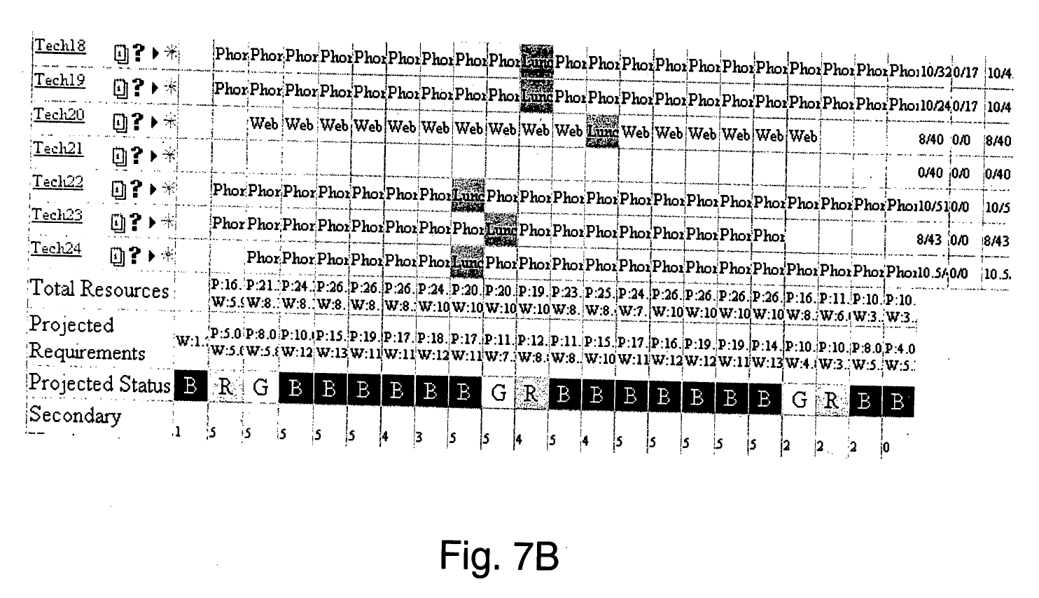

At this point the resource manager may choose to shuttle technicians from one time slot to another to overcome the “bad” rating. This is a simple procedure and is one of the many advantages of the disclosed invention. Referring to FIG. 7, the resource manager readily hovers the mouse over a technician to determine whether or not this person's schedule should be modified to correct the rating for the ninth time slot. By merely passing the cursor over the technician's name, in this instance “Technician 11,” important data is brought up which is needed to form the basis for the resource manager's decision regarding movement of a technician from one time slot to another.

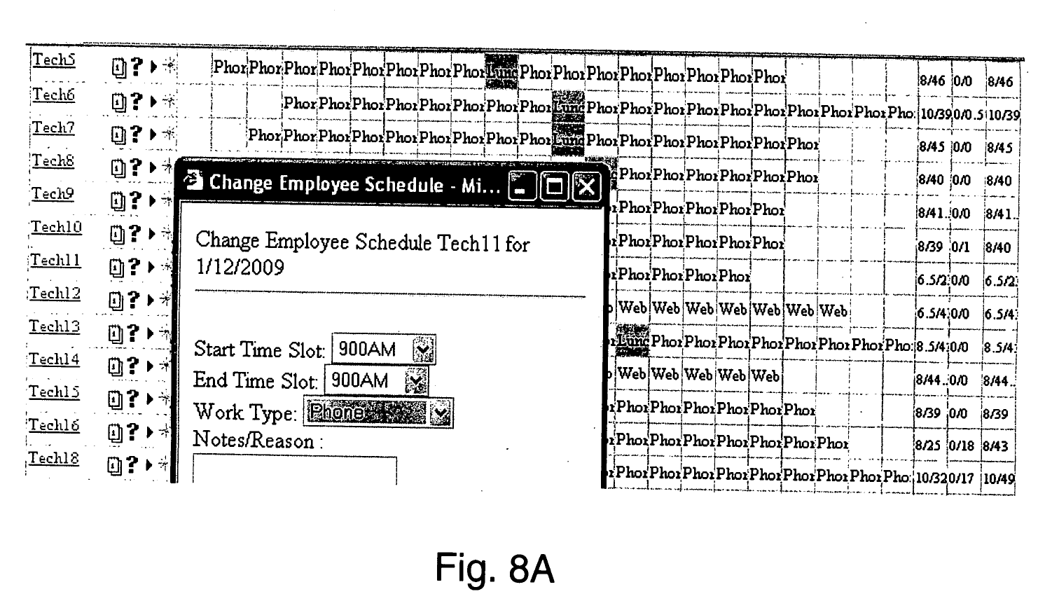

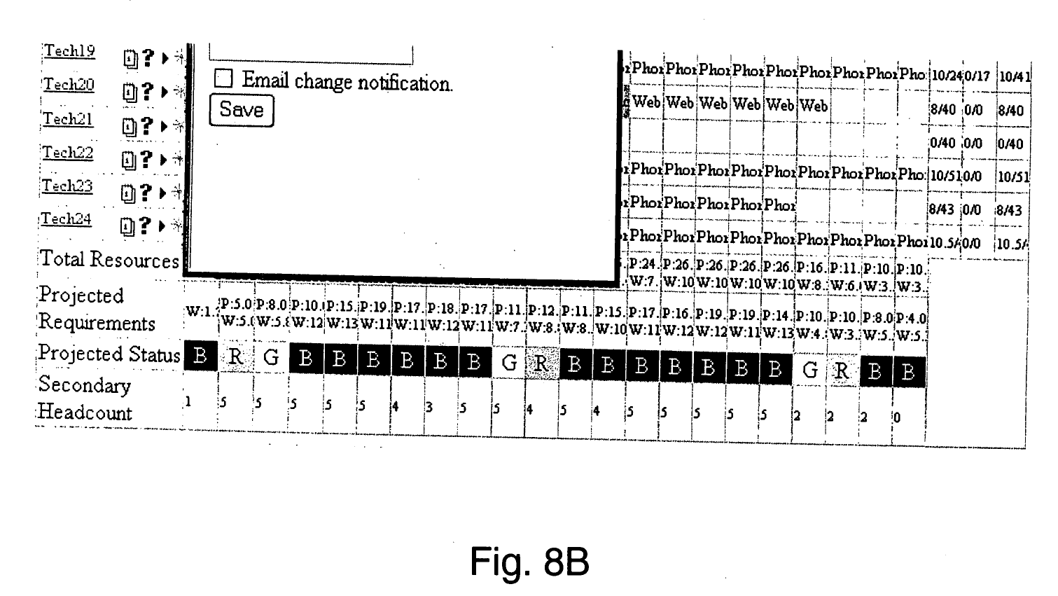

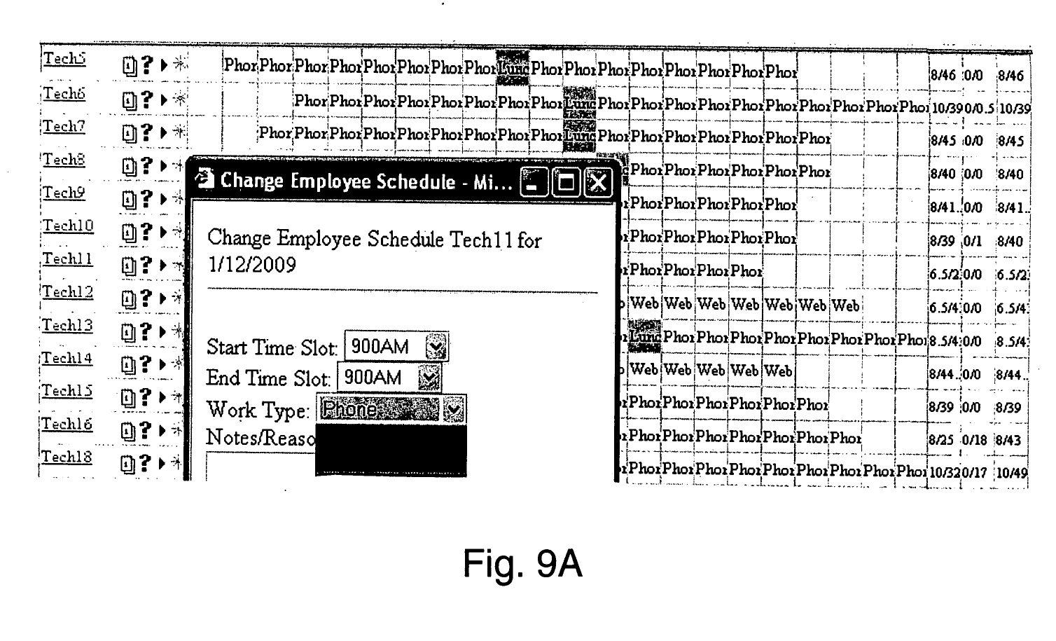

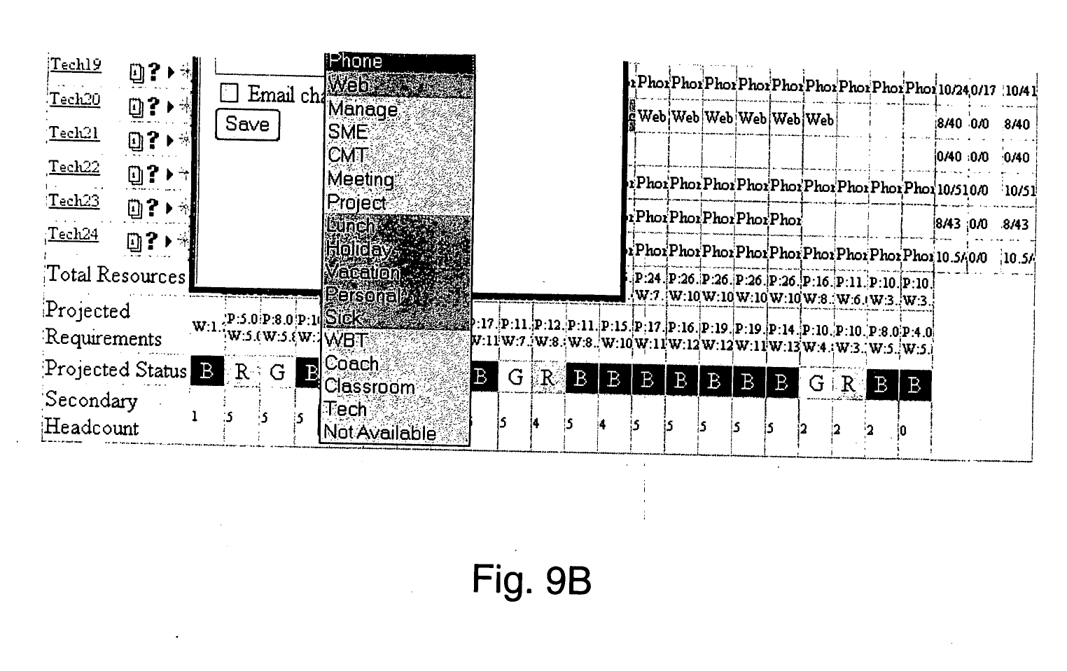

Particularly, the resource manager can see that Technician 11 has an adjusted phone-based inquiry efficiency of 0.0 responses per hour yet has an adjusted web-based inquiry efficiency of 4.32 responses per hour. Given that the ninth time slot is weak on the web-based efficiency the resource manager decides to move this employee to cover the ninth time slot for web-based inquiry responses. Through a simple manipulation while still hovering over the same screen and technician the resource manager opens up the employee schedule as illustrated in FIG. 8, clicks on the drop down “work type” as shown in FIG. 9, and changes the “work type” as appropriate to overcome the deficiencies of the ratio between “total resources” and “projected requirements” for that given time segment.

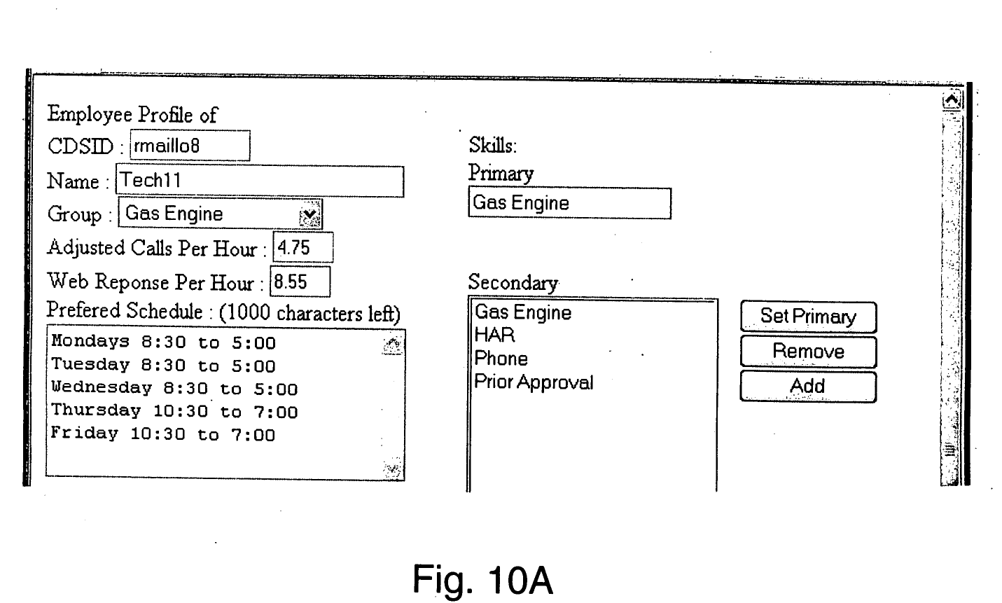

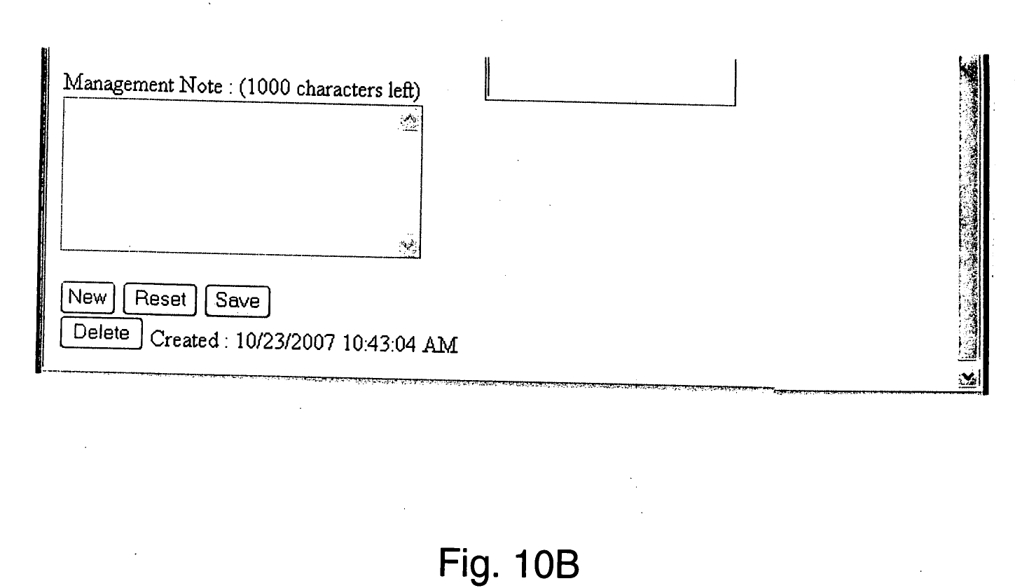

It may be that the resource manager finds that due to increased inquiry volume of all types there are not enough technicians available to provide adequate coverage. In such a case the resource manager may need to investigate whether or not any of the technicians available have the requisite skills. As shown in FIG. 10, both “primary” skills and “secondary” skills are identified. Both skills are identified in advance and this data is loaded into the system thus enabling the resource manager to immediately review this information on as as-needed basis without having to view alternate administrator screens. If the need arises and if a given technician has a secondary skill that is needed to increase operational efficiencies the resource manager is able to change the technician's profile so that the “secondary” skill is now a “primary” skill.

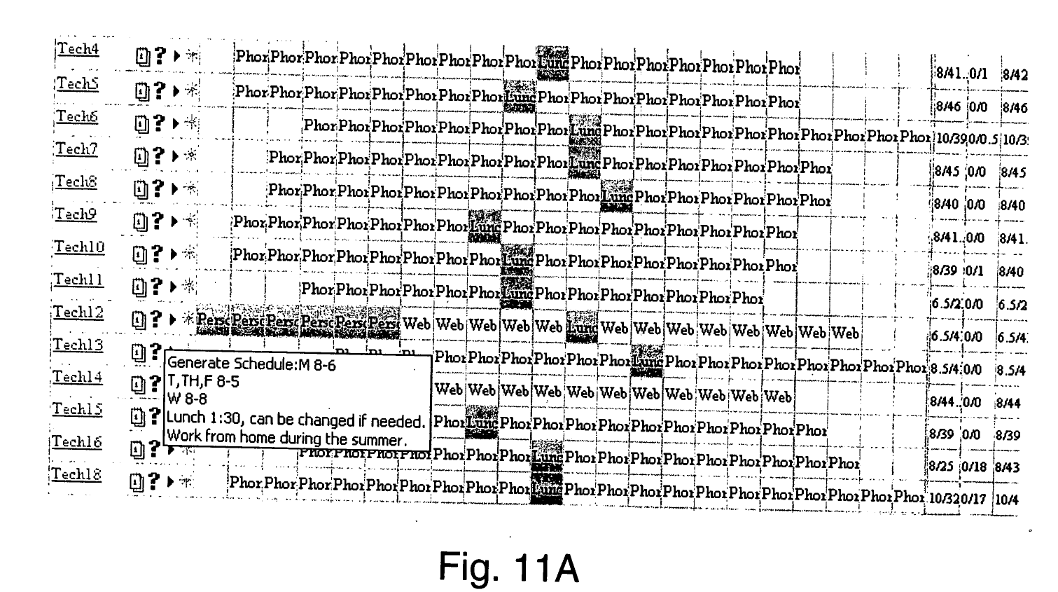

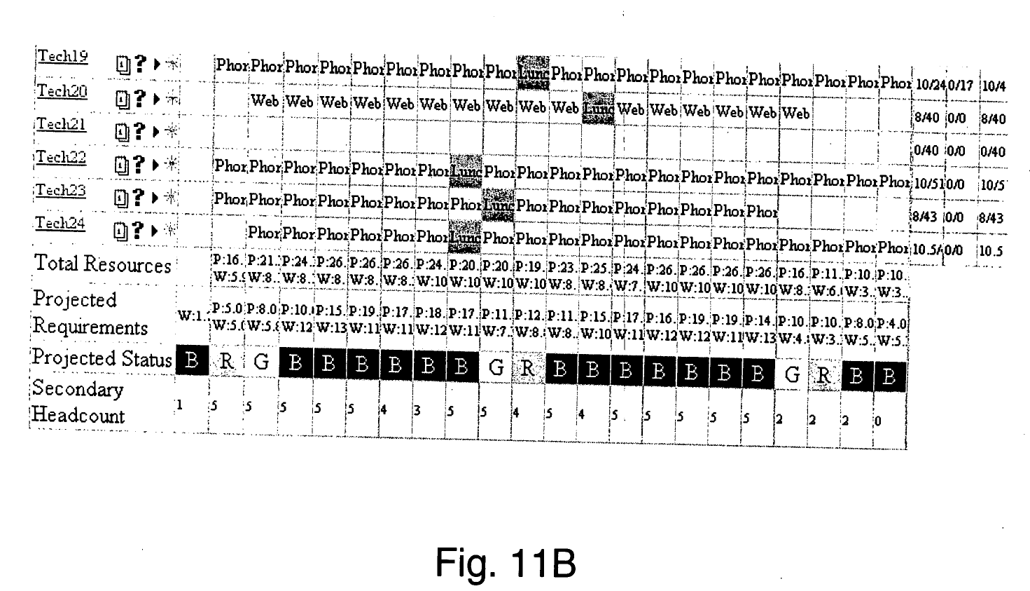

With reference to FIG. 11, in the event that the resource manager needs to consider other changes such as schedule changes the mouse may simply be moved to hover over a technician's name to bring up employee work availability. For example, in this figure the employee's schedule is shown for Monday 8-6, Tuesday, Thursday and Friday, 8-5, and Wednesday 8-8, with a flexible lunch time of 1:30 and a note that the employee works from home during the summer. With this information immediately available the resource manager can make changes quickly as needed to adjust the employee's schedule for optimum system efficiency.

The single resource management system and method disclosed herein offers several advantages beyond those specifically identified above. The scheduling tool embodied in the disclosed resource management system allows for and identifies differences in the output capabilities of experienced employees, newly-hired employees, and newly cross-trained employees. The schedules created remain consistent with the employee for a selected period of time, such as a month, thus reducing complaints from the employees about frequent schedule changes. This schedule predictability creates an improved balance of work and life for the employees.

Improved scheduling made possible through use of the disclosed resource management system also provides efficiencies in the form of reduced overtime hours without the need to compromise response time or response quality by assuring full coverage even during the busiest times. Various shifts are provided to maximize coverage when most needed.

Although not productive work, basic, advanced or supplemental employee technical training, cross-training, and peer review sessions are mandatory events required to maintain a high standard for service quality. The resource management system disclosed herein helps to identify the optimum times to schedule training. In addition, the management system of the disclosed invention provides greater consistency in identifying meetings and projects which might impact productivity and allows scheduling with these events in mind.

Importantly, “real time adherence” (RTA)—the comparison of ideal schedules to day-to-day realities—can be achieved using the instant resource management system. Specific the impact of daily events such as lunches, meetings, projects, training, vacation and sick time on the planned schedule can be readily evaluated and adjustments made as needed.

The resource management system described herein may be modified in several ways without deviating from the scope of the disclosed invention. For example, the system may be enhanced to provide predictive schedule modeling capabilities, such as modeling for new prior approval programs or modeling for web-based “first contact.” In addition, the system may be modified to provide a smart calculation of “total workload” by using combined historical data for both telephone-based and web-based inquiries. Another enhancement may be additional reporting capabilities, including training time, overtime, sick time, CMT/SME, productive vs. non-productive time, miscellaneous projects and meeting time.

The disclosed invention has application in any call center having more than one form of incoming inquiry (telephonic, web-based, other) and where there are plural agents (perhaps over 20) having diverse technical skill.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

1. A system for managing resources available to a contact center in response to both telephone-based and web-based inquiries, the system comprising:
an employee availability listing component;
an employee profile component, said employee profile component including employee skill identification;
a request listing component; and
a routing component for routing a request to an employee based on availability and skill.

2. The system for managing resources of claim 1 wherein said employee availability listing component includes a maintenance screen, said screen being capable of displaying data selected from the group consisting of the identities of the employees in a group, employee availability at a given time, scheduled overtime, time off, status of schedule approvals or changes, and scenarios that might arise due to employee unavailability due to illness, early departure, a change in employee work type, or transfer to a different work group.

3. The system for managing resources of claim 2 wherein said displayed data enable the identity of schedule blocks that may be at risk of inadequate employee representation.

4. The system for managing resources of claim 1 wherein said employee availability listing component includes an employee-manipulable work schedule.

5. The system for managing resources of claim 4 wherein an employee can report an absence through said employee-manipulable work schedule.

6. The system for managing resources of claim 1 wherein said employee availability listing component includes notification of schedule changes.

7. The system for managing resources of claim 1 wherein said employee availability listing component includes an employee schedule calendar.

8. The system for managing resources of claim 1 wherein said employee profile component includes primary skill identification and secondary skill identification.

9. The system for managing resources of claim 1 further including an incremental scheduling component for scheduling different work types for a given time increment.

10. The system for managing resources of claim 9 in which said work types are selected from the group consisting of telephone-based work, web-based work, training work, specified project work, and non-specified work.

11. The system for managing resources of claim 1 wherein said employee availability listing component is provided on a common schedule template for one or more groups of employees.

12. A method for responding to both telephone-based and web-based inquiries through a contact center, the method comprising the steps of:
receiving an inquiry;
identifying a group;
identifying the schedule of that group;
identifying employee availability of the members of the group;
identifying employee skill;
routing said inquiry to an available employee having an identified skill;
responding to said inquiry.

13. The method for responding to both telephone-based and web-based inquires of claim 12 including the step of listing data on a maintenance screen, said data being selected from the group consisting of the identities of the employees in a group, employee availability at a given time, scheduled overtime, time off, status of schedule approvals or changes, and scenarios that might arise due to employee unavailability-due to illness, early departure, a change in employee work type, or transfer to a different work group.

14. The method for responding to both telephone-based and web-based inquires of claim 12 including the step of allowing employees to adjust work schedules on-line.

15. The method for responding to both telephone-based and web-based inquires of claim 12 including the step of providing notification as to employee schedule changes.

16. The method for responding to both telephone-based and web-based inquires of claim 12 including the step of providing incremental scheduling information for scheduling different work types for a given time increment.

17. A computer readable medium of instructions for providing resource management and for controlling a real time contact center to receive telephone-based and web-based inquiries and to respond to these inquiries, the computer readable medium of instructions comprising:
a first set of data representing employee availability; and
a second set of data representing employee profiles including an employee's skills, wherein said employee profiles drive the intelligent input to real time contact center scenarios based upon said employee availability and said employee profiles.

18. The computer readable medium of instructions of claim 17 including a third set of data representing inquiry routing.

19. The computer readable medium of instructions of claim 18 wherein said third set of data includes employee skill and performance metrics.

20. The computer readable medium of instructions of claim 18 including a fourth set of data representing timekeeping.
